(19) United States
(12) Patent Application Publication
(10) Pub. No.: US 2003/0014128 A1
(43) Pub. Date: Jan. 16, 2003

(54) System, method, and apparatus for measuring application performance management

(76) Inventors: Jogen K. Pathak, Irving, TX (US); Shridhar Krishnamurthy, Coppell, TX (US); Rangaprasad Govindarajan, Plano, TX (US)

Correspondence Address: R. Scott Rhoades, Strasburger & Price, L.L.P., Suite 4300, 901 Main Street, Dallas, TX, 75202-3794, US

(21) Appl. No.: 10/192,417

(22) Filed: Jul. 10, 2002

Related U.S. Application Data
(60) Provisional application No. 60/304,327, filed on Jul. 10, 2001.

(51) Int. Cl. G05B 11/01

(52) U.S. Cl. 700/14

(57) ABSTRACT

A method and apparatus for measuring application performance over a wireless data network is presented herein. A wireless content switch is placed between a wired network and a wireless client such that data packets sent from the wired network to the wireless client and vice versa are received at the wireless content switch. The wireless content switch examines the protocol stack and data associated with the data packet and measures the performance of applications. The performance of applications is measured using one of a plurality of measures, based on the type of application associated with the data packet. Wherein an application is found to be associated with low performance, graceful degradation can be imposed.

### CROSS-REFERENCE TO RELATED APPLICATIONS

This application claims the priority benefit of U.S. Provisional Application for Patent, Serial No. 60/304,327, entitled “System, Method, And Apparatus For Measuring Application Performance Management,” filed on Jul. 10, 2001, which is hereby incorporated by reference for all purposes.

### STATEMENT REGARDING FEDERALLY SPONSORED RESEARCH/DEVELOPMENT

Not Applicable.

### FIELD

The present invention is related to wireless internet services, and more particularly to a method, and apparatus for measuring application performance.

### BACKGROUND

Mobile computing with wireless links is expected to be an integral part of current and future third generation networks. Current and future third generation wireless networks like UMTS are being designed to deliver pictures, graphics, video communications, and other wideband information as well as voice and data. The number of worldwide wireless subscribers is expected to reach 1.7 billion by the year 2005 and 500 million wireless users accessing the internet from some type of wireless devices.

In data networks, quality implies the process of delivering data in a reliable and timely manner, where the definition of reliable and timely differs, based upon the type of traffic being addressed. A casual user doing occasional web browsing, but no file transfer protocol downloads or real-time multimedia sessions, may have a different definition of the quality of service than a business user of large databases of financial files, multimedia conferencing and voice over internet telephony. Therefore, quality of service is a continuum, defined by the network performance characteristics that are most important to users for the type of applications that the users are using and the particular service level agreements which the user has purchased from the wireless service providers. Higher billing rates must meet higher quality of service and experience requirements.

Application performance measurement measures the quality of service delivered to endusers by applications. With this in perspective, a true end-to-end view of the data infrastructure results, combining the performance of the application, device, network, and user, as well as any positive or negative interactions between these components.

Application performance measurements typically measure application performance on a macroscopic level and on a network wide basis. Such performance measurements include raw bandwidth usage or bit rate of the pipe. The foregoing performance measurements are do not provide sufficient analysis of quality of the service provided to the customers because the quality of service varies based on the user's application and service level agreements.

More useful application performance requires measurements at the user, and even transaction level. Providing application performance at the user or transaction level requires analysis within the protocol layers of the data packet. Current vendor equipment does not provide for analysis of data packets at lower level protocol layers. Accordingly, it would be beneficial if application performance in a wireless network could be measured on a user or transaction level.

### SUMMARY

A method and apparatus for measuring application performance over a wireless data network is presented herein. A wireless content switch is placed between a wired network and a wireless client such that data packets sent from the wired network to the wireless client and vice versa are received at the wireless content switch. The wireless content switch examines the protocol stack and data associated with the data packet and measures the performance of applications. The performance of applications is measured using one of a plurality of measures, based on the type of application associated with the data packet. Wherein an application is found to be associated with low performance, graceful degradation can be imposed.

### BRIEF DESCRIPTION OF THE DRAWINGS

FIG. 1 is a block diagram of a wireless data services network;

FIG. 2 is a block diagram of an exemplary wireless content switch;

FIG. 3 is a block diagram of an exemplary data packet protocol stack;

FIG. 4 is an exemplary request table; and

FIG. 5 is a block diagram of an information handling system.

### DETAILED DESCRIPTION OF THE DRAWINGS

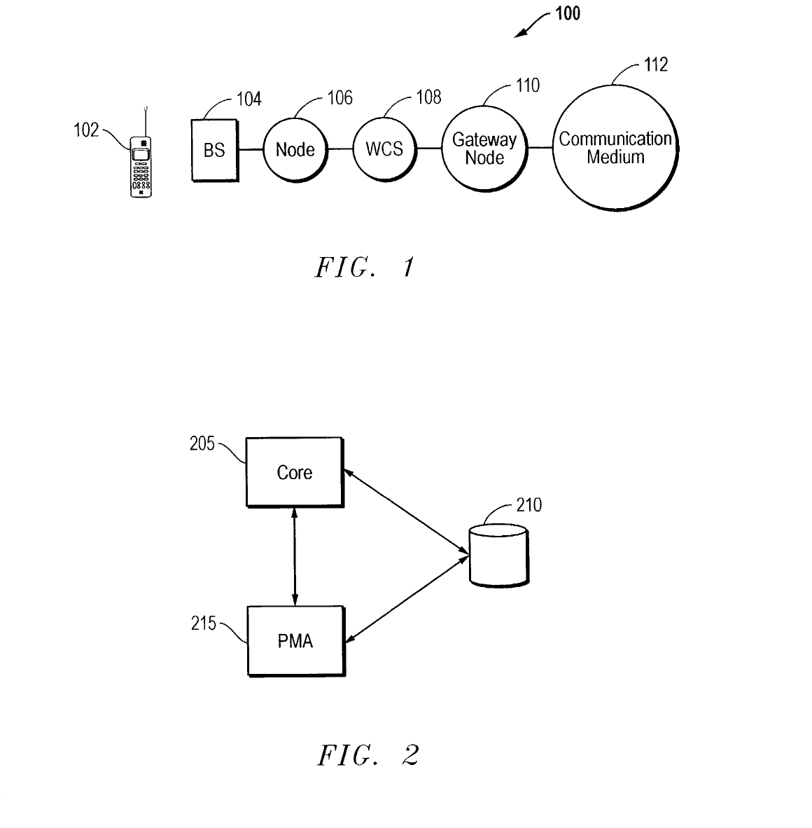

Referring now to FIG. 1, there is illustrated a diagram of a system 100 for providing wireless data services. The system 100 includes wireless client 102, base station, 104, serving node 106, wireless content switch 108, and gateway node 110, which is coupled to communications medium 112. Communications medium 112 can be the internet, a local area network, a wide area network, a fiber optic network, the public switched telephone network, other suitable media, or a suitable combination of such media. Mobile station 102, base station system 104, serving node 106, and gateway node 110 form a standard logical radio packet data transmission network. Wireless content switch 108 is coupled anywhere between gateway node 110 and wireless client 102, such as in the illustration wherein the wireless content switch 108 is located between the gateway node 110 and the serving node 106.

Wireless content switch 108 can receive GPRS tunneling protocol format packet data from gateway node 110, and can determine additional processing that may be required based upon the mobile station 102, the type of content in the packet, priority data, quality of service data, multicasting functionality, or other suitable functions.

Likewise, wireless content switch 108 can receive GPRS tunneling protocol packet data from serving node 106, and can process the GPRS tunneling protocol packet data to performance additional functionality prior to transmitting the packet data to gateway node 110. Wireless content switch 108 thus interfaces seamlessly into the GPRS standard network to provide additional wireless data processing functionality that cannot presently be provided from the server or mobile station 102. For example, if server 114 is a wireless application server that is performing quality of service management over communications medium 112, it would not be able to readily determine the status of gateway node 110 and serving node 106, such as the total bandwidth being used, the bandwidth being used in a virtual private network, operable mobile stations, or other suitable status data. Likewise, deploying wireless content switch 108 at server 114 limits the functionality that can be provided by wireless content switch 108 to packet data being provided through server 114 to mobile station 102. By deploying wireless content switch 108 between gateway node 110 and the wireless client 102, it is possible to provide wireless content switching functionality on radio packet data regardless of whether it comes from server 114 or from any other server accessible over communications medium 112.

The wireless content switch 108 is capable of deep data packet analysis, enabling the wireless content switch 108 to monitor the protocol layers and data inside the data packets passing thereon. From information extracted from the protocol layers and data of the data packets, the wireless content switch 108 can perform application performance measurements.

Referring now to FIG. 2, there is illustrated a block diagram describing the wireless content switch 108. The wireless content switch 108 includes a core 205, a repository 210, and a performance measurement terminal 215. The core 205 receives data packets that are transmitted between the wireless clients 102 and the server 114. Upon receiving the data packets, the core 205 analyzes the data packets and captures certain data from the data packets. The data that is captured from the data packets is stored in the repository 210.

The repository 210 is a database which stores and preprocesses the raw data captured at the core 205. The stored and preprocesses data are accessible by the performance measurement terminal 215. The preprocessing includes preparation of aggregate tables from which specific measures can be calculated. The performance measurement terminal 215 can include a computer system with an appropriate graphical user interface which assists a user in requesting certain data from the repository 210 and displaying the data from the repository 210.

The wireless content switch 108 can operate in one of two different modes—a static mode, and a real-time mode. In the static mode, the user can provide constraints which specify capture of information from particular data packets satisfying the provided constraints. The captured information is forwarded to the repository 210 for storage. The repository 210 generates any number of aggregate tables which aggregate certain predetermined measures from the information captured from the data packets. The aggregate tables aggregate the predetermined measures with a relatively high level of granularity. The PMA terminal 215 can request display of certain measures at various levels of granularity, and with various constraints, provided that the constraints were supported by the initial constraints used to specify the capture of the information.

In the real-time mode of operation, the user provides constraints which specify capture of information from particular data packets satisfying the provided constraints, as well as the measures, levels of granularity, and constraints associated therewith. The core 205 keeps a running count of measure which is updated responsive to receipt of a packet of data which contains the information specified in the constraints. The running count is forwarded to the PMA terminal 215 at specified periodic intervals, and reset and calculated for the next periodic interval.

Referring now to FIG. 3, there is illustrated a block diagram of an exemplary data packet protocol stack 300. It is noted that certain details are not described for purposes of clarity. Therefore, the figure is not intended to be exhaustive. The data protocol stack includes a physical layer 305, a data link layer 310, a network layer 315, transport layer 320, and an application layer 325.

Each layer includes a header and payload, wherein the payload comprises the header and payload of the next layer. For example, the payload of the physical layer 305 includes the header 310a and payload of the data link layer 310, the payload of the data link layer 310 includes the header 315a and payload of the network layer 315, etc.

The physical layer 305 is the most accessible layer. The core 205 accesses other layers of the stack by reading and stripping off the successive headers of previous successive layers. The information contained in the headers of each layer is used for performance measurements.

The data link layer 310 commonly includes the Ethernet protocol. The foregoing Ethernet protocol includes information such as the physical Source/Destination Addresses in accordance with MAC. The network layer 315 commonly includes the Internet Protocol. The Internet Protocol includes the IP addresses of the content server and the wireless client. The transport layer 320 commonly includes the Transmission Control Protocol (TCP). The TCP contains the source and destination port numbers. Additionally, the TCP contains information related to the delivery and recovery of packets. Wherein the data packet is among a succession of data packets, the TCP contains an indication of the order of the data packet in the succession. The TCP also contains acknowledgments which indicate receipt of a particular packet number. The application layer 325 includes a definition of the particular application pertaining to the packet.

Common examples of applications include the hypertext transmission protocol (http), file transfer protocol (ftp), and simple mail transmission protocol (SMTP), to name a few. The headers of each of the foregoing contain a field which indicates the Uniform Resource Location (URL) for the packet. For example, wherein the packet is associated with a web page, the URL will contain the web page address.

The wireless content switch 108 is capable of analyzing the protocol stack 300 associated with data packets and the commands and data associated therewith. A user at the PMA terminal 210 can provide constraint for the foregoing packet information to the core 205. The packet information corresponding to the foregoing constraints is either captured and stored in the repository 210, or used to update the running count maintained by the core 205. The core 205 captures the requested data by analyzing the incoming data packets, parsing the level headers, and returning the requested information to the repository 215. The measurements are provided in a measurement table which is provided to the PMA terminal 210.

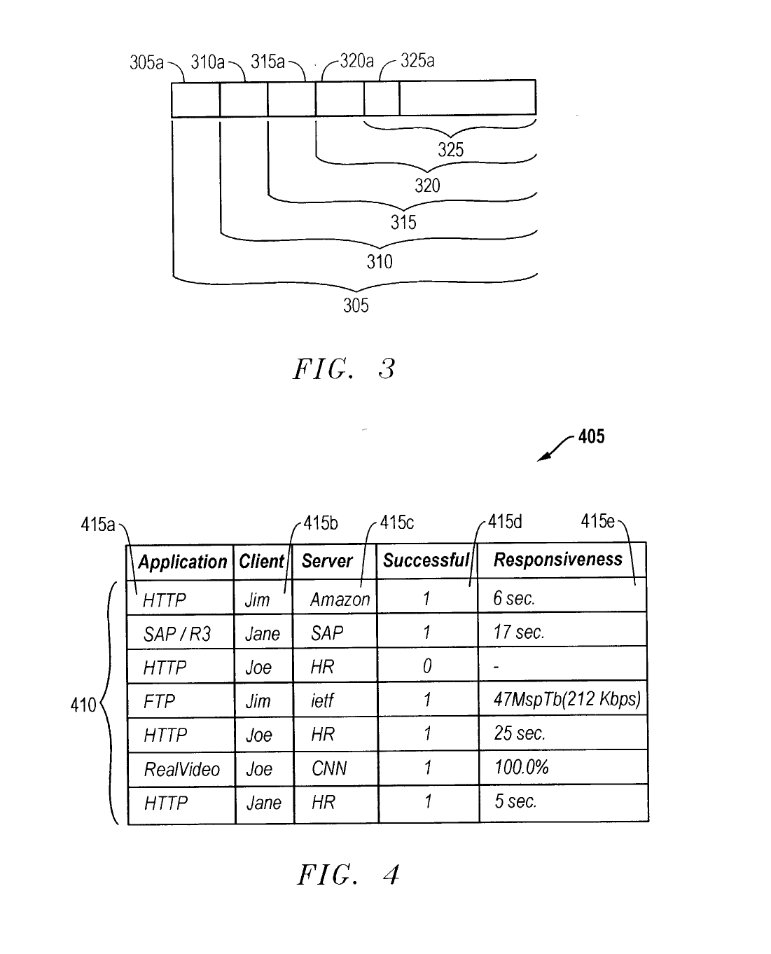

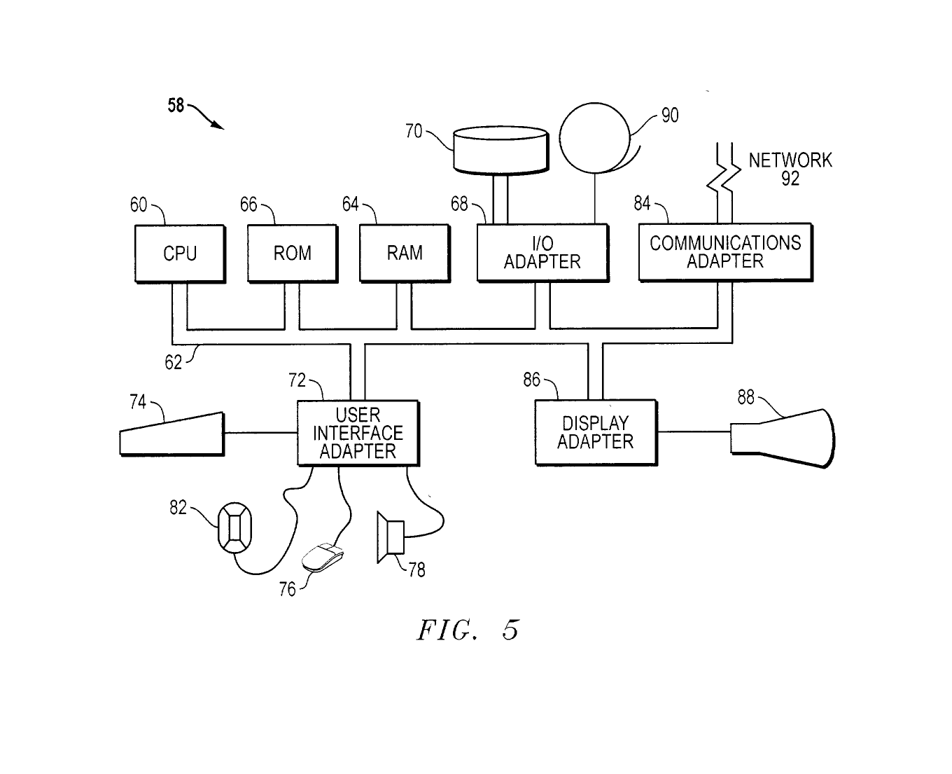

Referring now to FIG. 4, there is illustrated an exemplary request table 405. The request table 405 stores a plurality of records 410. Each records 410 comprises indicators identifying the application type 415a, the wireless client 415b, the content server 415c, whether the request was successful 415d, and the performance of the application 415e.

Upon receipt of a request from a wireless client 102, the wireless content switch 108 creates and stores a record 410 which includes the application type 415a, the wireless client 415b, and the server 415c. The indicator indicating whether the request was success was successful 415d and the indicator indicating the performance of the application 415e are initialized to indicate unsuccessful and zero.

While the application responds to the request, the wireless content switch 108 can monitor and measure the performance of the application. For example, wherein the wireless content switch 108 measures the application's performance based on the time elapsed, the wireless content switch 108 can track the time using the indicator indicating the application's performance 415e. Wherein the wireless content switch 108 measures the application's performance based on the throughput, the wireless content switch 108 can keep a running average of the throughput using the indicator indicating the application's performance 415e. Wherein the wireless content switch 108 measures the application's performance based on the ratio of time that throughput exceeds a certain predetermined threshold, the wireless content switch 108 can keep a running ratio of the time wherein the throughput exceeds a certain predetermined threshold.

Upon completion, the indicator indicating whether the request was successful 415d is set to indicate that the request was successful and the indicator indicating the application performance 415e stores the calculated application performance. However, wherein the request is not completed successfully, the indicator indicating success 415d is set to remain as unsuccessful.

The measurements 415e for the successfully completed requests in the session table 405 can also be aggregated using any one of a plurality of aggregation metrics. The aggregation metrics can aggregate measurements of application performance, wherein the application type is the same or similar. For example, the application performance measurements can be aggregated for each application type measured with elapsed time, each application type measured with average throughput, and each application type measured with ratio of time where throughput exceeded a predetermined threshold. The metrics can aggregate the measurements to yield such metrics as transaction count, total successful transactions, responsiveness mean, responsiveness minimum, and responsiveness maximum, to name a few.

There are also a number of different basis for aggregation of the measurements. For example, in one case, the measurements can aggregated for all transactions having a common application 415a, client 415b, and server 415c. In another case, the measurements can be aggregated for all transactions having a common application 415a and server 415c. In yet another case, the measurements can be aggregated for all transactions having a common application 415a and client 415b. In yet even another case, the measurements can be aggregated for all transactions having a common application 415a.

The foregoing aggregation metrics can be utilized to implement graceful degradation of services during periods of low responsiveness. For example, wherein response time for downloading web pages is found to be excessive, the wireless content switch 108 can restrict web page downloads to black and white pictures, or even restrict the web page download to text. Wherein streaming applications are associated with a low application performance, the wireless content switch 108 can restrict the streaming application to audio only, and exclude video. The application types can be gracefully degraded until application performance is found to have improved, at which time the application type can be upgraded.

Referring now to FIG. 5, a representative hardware environment is depicted and illustrates a typical hardware configuration of a computer information handling system 58, having at least one central processing unit (CPU) 60. CPU 60 is interconnected vita system bus 12 to random access memory (RAM) 64, read only memory (ROM) 66, and input/output (I/O) adapter 68 for connecting peripheral devices such as disc units 70 and tape drives 90 to bus 62, user interface adapter 72 for connecting keyboard 74, mouse 76 having button 67, speaker 78, microphone 82, and/or other user interfaced devices such as a touch screen device (not shown) to bus 62, communication adapter 84 for connecting the information handling system to a data processing network 92, and display adapter 86 for connecting bus 62 to display device 88.

Although the foregoing embodiments have been described with a certain degree of particularity, it should be recognized that elements thereof may be altered, modified, or substituted by persons skilled in the art without departing from the spirit and scope of the invention. One embodiment can be implemented as sets of instructions resident in the random access memory 64 of one or more computer systems configured generally as described in FIG. 5. Until required by the computer system, the set of instructions may be stored in another computer readable memory, for example in a hard disk drive, or in a removable memory such as an optical disk for eventual use in a CD-ROM drive or a floppy disk for eventual use in a floppy disk drive. Further, the set of instructions can be stored in the memory of another computer and transmitted over a local area network or a wide area network, such as the Internet, when desired by the user. One skilled in the art would appreciate that the physical storage of the sets of instructions physically changes the medium upon which it is stored electrically, magnetically, or chemically so that the medium carries computer readable information. The invention is limited only by the following claims and their equivalents.

What is claimed is:

1. A method for measuring performance for a plurality of applications, said method comprising:
receiving a plurality of transaction requests from a corresponding plurality of wireless clients;
measuring performance of a first portion of the transaction requests with a first measure, wherein the first portion of the transactions are associated with a first type of application; and
measuring performance of a second portion of the transaction requests with a second measure, wherein the second portion of the transactions are associated with a second type of applications.

2. The method of claim 1, further comprising:
measuring performance of a third portion of the transaction requests with a third measure, wherein the third portion of the transactions are associated with a third type of application.

3. The method of claim 2, wherein measuring performance of the third portion of the transaction requests further comprises:
measuring performance of the third portion of the transaction requests with a signal-quality ratio of time measure, wherein the third portion of the transactions are associated with streaming-oriented applications.

4. The method of claim 1, wherein measuring performance of a first portion of the transaction requests further comprises:
measuring performance of the first portion of the transaction requests with a time measure, wherein the first portion of the transactions requests are associated with transaction oriented applications.

5. The method of claim 1, wherein measuring performance of the second portion of the transaction requests further comprises:
measuring performance of the second portion of the transaction requests with a throughput measure, wherein the second portion of the transaction requests are associated with throughput oriented applications.

6. The method of claim 1, further comprising:
aggregating measurements for the first portion of the transaction requests; and
aggregating measurements for the second portion of the transaction requests.

7. The method of claim 6, wherein aggregating measurements for the first portion of the transaction requests further comprises:
calculating an average metric for the first portion of transaction requests; and
calculating a mean metric for the first portion of transaction requests.

8. The method of claim 6, wherein aggregating measurements for the first portion of the transaction requests further comprises:
calculating a maximum metric for the first portion of the transaction requests; and
calculating a minimum metric for the first portion of the transaction requests.

9. The method of claim 1, further comprising:
degrading the first type of applications wherein the performance of the first portion of transaction requests is found to be low.

10. An article of manufacture comprising a computer readable medium storing a plurality of executable instructions, said executable instructions further comprising:
receiving a plurality of transaction requests from a corresponding plurality of wireless clients;
measuring performance of a first portion of the transaction requests with a first metric, wherein the first portion of the transactions are associated with a first type of applications; and
measuring performance of a second portion of the transaction requests with a second metric, wherein the second portion of the transactions are associated with a second type of applications.

11. The article of manufacture of claim 10, wherein the plurality of executable instructions further comprises:
measuring performance of a third portion of the transaction requests with a third metric, wherein the third portion of the transactions are associated with a third type of applications.

12. The article of manufacture of claim 11, wherein the instructions for measuring performance of the third portion of the transaction requests further comprises instructions for:
measuring performance of the third portion of the transaction requests with a signalquality ratio of time metric, wherein the third portion of the transactions are associated with streaming-oriented applications.

13. The article of manufacture of claim 10, wherein the instructions for measuring performance of a first portion of the transaction requests further comprises instructions:
measuring performance of the first portion—of the transaction requests with a time metric, wherein the first portion of the transactions requests are associated with transaction oriented applications.

14. The article of manufacture of claim 10, wherein the instructions for measuring performance of the second portion of the transaction requests further comprises instructions for:
measuring performance of the second portion of the transaction requests with a throughput metric, wherein the second portion of the transaction requests are associated with throughput oriented applications.

15. The article of manufacture of claim 10, wherein the plurality of instructions further comprises:
aggregating measurements for the first portion of the transaction requests; and
aggregating measurements for the second portion of the transaction requests.

16. The article of manufacture of claim 15, wherein the instructions for aggregating measurements for the first portion of the transaction requests further comprises instructions for:
calculating an average measurement for the first portion of transaction requests; and
calculating a mean measurement for the first portion of transaction requests.

17. The article of manufacture of claim 15, wherein the instructions for aggregating measurements for the first portion of the transaction requests further comprises instructions for:
calculating a maximum measurement for the first portion of the transaction requests; and
calculating a minimum measurement for the first portion of the transaction requests.

18. The article of manufacture of claim 10, wherein the plurality of executable instructions further comprise:
degrading the first type of applications wherein the performance of the first portion of transaction requests is found to be low.
